(19) United States
(12) Patent Application Publication
(10) Pub. No.: US 2013/0050118 A1
(43) Pub. Date: Feb. 28, 2013

(54) GESTURE-DRIVEN FEEDBACK MECHANISM

(71) Applicants: Jens Kjelsbak, Vaerloese (DK); Jesper Hart-Hansen, Lyngby (DK); John McElligott, Frederiksberg (DK); Luke Shardlow, San Francisco, CA (US)

(72) Inventors: Jens Kjelsbak, Vaerloese (DK); Jesper Hart-Hansen, Lyngby (DK); John McElligott, Frederiksberg (DK); Luke Shardlow, San Francisco, CA (US)

(73) Assignee: eBay Inc., San Jose, CA (US)

(21) Appl. No.: 13/596,596

(22) Filed: Aug. 28, 2012

Related U.S. Application Data
(60) Provisional application No. 61/528,612, filed on Aug. 29, 2011.

(51) Int. Cl. G06F 3/01; G06F 3/041

(52) U.S. Cl. 345/173; 345/156

(57) ABSTRACT

Systems and methods disclosed herein may operate to detect, via a user device corresponding to a user, a user gesture performed on or in proximity of the user device during execution of a user interface in relation with an application; compare the user gesture against at least one predetermined gesture; and generate a feedback message associated with the application based on determining that the user gesture matches the at least one predetermined gesture, with the generating including automatically capturing a screen image of the user interface and inserting the screen image as at least part of the feedback message.

### CROSS-REFERENCE TO RELATED APPLICATIONS

This application claims the benefit of U.S. Provisional Application No. 61/528,612, filed Aug. 29, 2011, which is incorporated herein by reference in its entirety.

### TECHNICAL FIELD

The present application relates generally to the technical field of graphic user interface management and, in various embodiments, to systems and methods for controlling a graphical user interface of a user device based on gestures.

### BACKGROUND

Various types of user devices, such as smartphones and tablet computers, are now used on a daily basis for business transactions (e.g., purchase, sell, rent, auction, and so on) of items, goods or services, through a network-based online store, such as eBay.com, Target.com, Amazon.com, AMC.com and some similar online marketplaces. The user devices are also used for non-business transactions (e.g., write, read, and search for an email). A general application (e.g., a web browser) or a native application (e.g., a task-specific application, such as a stock-trading application or an email application) may be used (e.g., executed) on a user device (e.g., a smartphone) to help a user accomplish a business or non-business activity or transaction.

### BRIEF DESCRIPTION OF THE DRAWINGS

Some embodiments are illustrated by way of example and not by way of limitation, in the figures of the accompanying drawings.

FIG. 1 is a schematic diagram illustrating example gestures to trigger a gesture-driven feedback mechanism, according to various embodiments.

FIG. 2 is a schematic diagram illustrating a user interface for a gesture-driven feedback mechanism, according to various embodiments.

FIG. 3 is a block diagram illustrating a system in a network environment for a gesture-driven feedback mechanism, according to various embodiments.

FIG. 4 is a schematic diagram illustrating example modules to execute a gesture-driven feedback mechanism, according to various embodiments.

FIG. 5 is a flow diagram illustrating a method for generating a feedback message based on a user gesture, according to various embodiments.

FIG. 6 is a flow diagram illustrating a method for activating functions of a user device based on a user gesture, according to various embodiments.

FIG. 7 is a diagrammatic representation of a machine in the example form of a computer system, according to various embodiments.

### DETAILED DESCRIPTION

Example methods, apparatuses, and systems to generate a feedback message based on a user gesture detected via a user device are disclosed herein. In the following description, for purposes of explanation, numerous specific details are set forth in order to provide a thorough understanding of the present disclosure. It may be evident, however, to one skilled in the art, that the subject matter of the present disclosure may be practiced without these specific details.

With respect to using a general or native application described above, in various situations, the user may need to transmit his feedback in relation to the application being executed to a (e.g., network-based) service provider affiliated with a service provided by the application. For example, the user may want to ask the service provider (e.g., its customer service center) for technical support with respect to a certain flow (e.g., function) of a certain user interface in relation with the application. In addition to or as an alternative to the request for the technical support, the user may want to report a system error (e.g., malfunction) or incorrect data (e.g., outdated data) in relation with the application upon encounter of such problems. In other cases, the user may want to suggest some ideas to the service provider to improve the application or the service provided via the application.

Conventionally, in order to send feedback to the service provider, the user has to leave (e.g., navigate) a current page of a current user interface in relation with the application and go to a designated feedback area, or select a designated feedback menu button. This process to navigate through one or more pages related to one or more user interfaces to the designated feedback area or the designated feedback menu button can be cumbersome, frustrating and time consuming. This is true, for example, when a design of the user interface(s) of the application is inefficient, for example, with respect to a layout of a plurality of pages within the scope of the application, or a layout of a plurality of menu buttons within a given page of the plurality of pages. This problem may worsen, for example, when performance (e.g., speed) of the service is deteriorating due to heavy network traffic, a system malfunction, and so on.

In addition, in certain situations, even after finding a user interface for leaving feedback, the user may have difficulty choosing an appropriate type (e.g., category) of feedback menu from a plurality of menus (e.g., function buttons). This is because, for example, existing technologies do not take into consideration a current flow of the application being executed at the time of the need for the user to leave (e.g., transmit) his feedback to the service provider. As a result, users may leave their feedback under categories that are not best suited for original intention of the system provider. This in turn may result in a set of unorganized or unrelated feedback data (e.g., a feedback database) on the service provider's side.

Furthermore, even if an appropriate feedback menu (e.g., a user interface) is found and selected, the user may need to provide (e.g., write) too much or difficult information, for example, to describe an environment (e.g., status or flow of the user interface) of the application at the time of occurrence of the need for the feedback (e.g., a system improvement proposal or a (system or data) error report). Accordingly, under the existing technologies, because of one or more of the problems described above, the user may rather choose not to leave feedback, or to leave as little information as possible as the feedback. This may in turn lead to incorrect or insufficient contents for the application status related to the feedback such that the service provider may be unable to respond the feedback without going through an additional situation-inquiry process. For example, upon receiving the feedback from the user via his user device, a customer service staff at a customer center affiliated with the service provider may need to call the user and ask him one or more questions regarding a cause of his feedback or a related system status, and so forth.

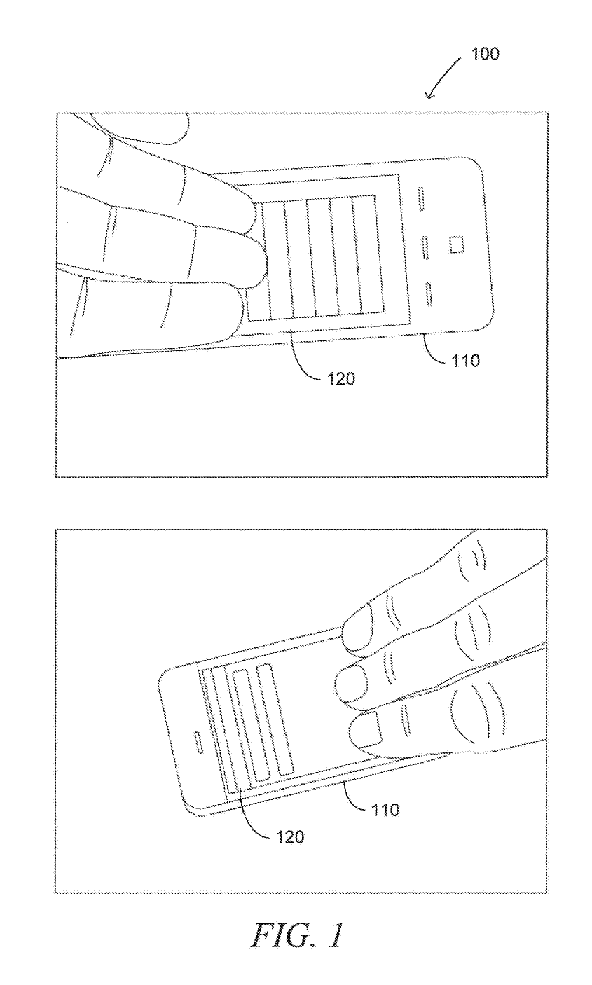

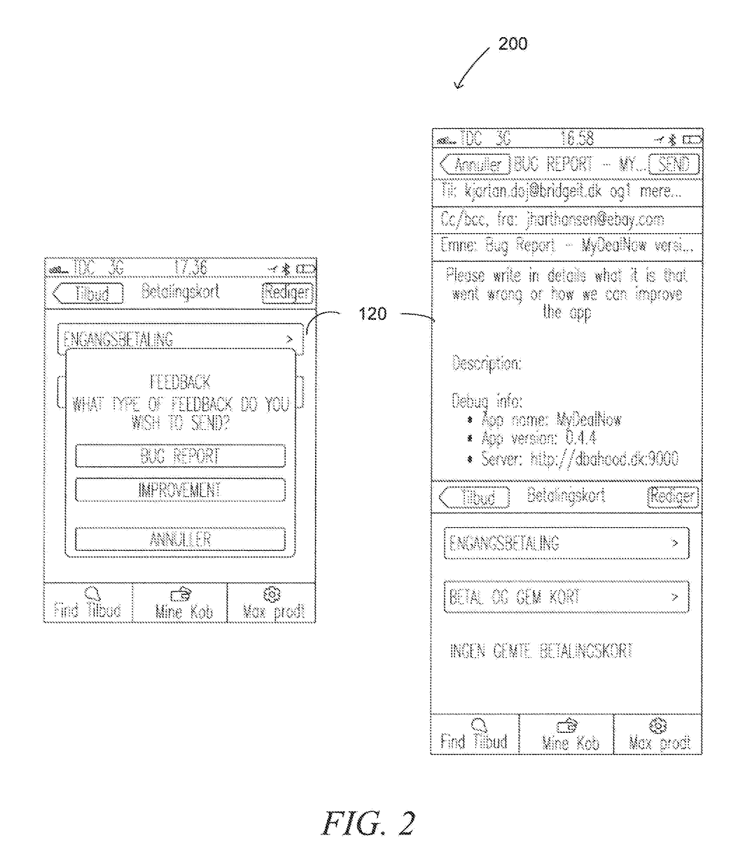

The above-described problems and other problems under the existing technologies may be solved by using a gesture-driven feedback mechanism, according to various embodiments. For example, FIGS. 1-2 show schematic diagrams 100, 200 illustrating example gestures (shown in FIG. 1) to trigger a gesture-driven feedback mechanism including a feedback user interface (shown in FIGS. 1-2), according to various embodiments. Referring to FIGS. 1-2, a feedback module (not shown) may reside within an application executing on a user device 110 (e.g., a mobile device, such as a smartphone or a tablet computer). The feedback module may enable a user to generate feedback for any portion of the application, such as a listing process, a voucher generation process, a voucher redemption process, or any user interface or functionality presented in the application. Using a gesture on or in proximity of a display (e.g., a touch screen) recognized by the application, the feedback module may present a user with a feedback user interface 120 (e.g., a dialog box as shown in FIG. 1) for entering feedback about a particular aspect of the application. For example, a user may perform a recognized touch gesture using three fingers that are moved in an upward (as shown in an upper portion of FIG. 1) or downward (as shown in a lower portion of FIG. 1) motion on a multi-touch display. Other touch or non-touch user gestures may also be implemented within various embodiments to activate a feedback mechanism.

In various embodiments, upon detecting the user gesture, the feedback module may capture the process (e.g., flow), such as listing, search, checkout, and so on, of the application that the user was performing at the time of the gesture, and may provide (e.g., trigger) the user with a contextual feedback page (e.g., the feedback user interface 120) that is specific to that process. For example, the feedback page may provide a customized help interface for the user directed to the process of the application the user was using when the gesture was performed, provide contact to a customer support representative for the process of the application the user was using when the gesture was performed, or allow the user to leave direct feedback linked to an action the user was taking in the process of the application at the time of the gesture.

In various embodiments, the feedback module may perform a screen capture of the application (e.g., a user interface) at the time of the (recognized) user gesture being detected. Also, when triggered, the feedback module may perform another screen capture of the feedback user interface 120 containing, for example, the feedback dialog box (as shown in FIG. 1). The feedback module may transmit at least one of the screen capture images and/or other feedback data provided by the user, for example, as an e-mail to a service provider (e.g., eBay.com or Amazon.com, etc.) affiliated with (e.g., providing) the service performed via the application. The image of the feedback may be tagged with metadata describing the circumstances of the feedback, such as a time stamp, a location of the user, an aspect of the application for which feedback is being left, and so on. Thus, the user is no longer restricted to leaving feedback only within designated areas of the application or only in response to a certain sequence of events occurring (e.g., at the end of a transaction).

In various embodiments, as an illustrative example, a user may have completed some steps in relation with a selling process of a (e.g., eBay) mobile application, and may be currently in a certain (e.g., listing) flow of the selling process about which he is confused or otherwise unsure how to continue for the next step. The user has previously set an “S” gesture as his “help me” gesture. Accordingly, the user may perform the “S” gesture on or in proximity of the screen of his mobile device. When the “S” gesture is detected and recognized by his mobile device, the user may be prompted with a page that overlays the mobile application and asks the user these questions: Would you like to “request for assistance,” “leave feedback,” “rate the application,” “report an error,” or “suggest improvement idea?” Responsive to selecting the “request for assistance” portion (e.g., button), the user may be called on his phone by a customer support agent who is informed regarding in which flow of the mobile application the user was at the time of the “help me” gesture being detected. During the call, the user and the agent may return to the same point in the flow of without taking a risk of losing what he was engaged in so that the agent can assist the user with the problem in a faster or efficient manner. Alternatively, in some embodiments, the “help me” (e.g., “S”) gesture may simply have the agent directly dial the customer without using the interstitial page (e.g., the page asking the (selection) question).

In various embodiments, as another illustrative example, a user (e.g., the same user as in the above-described example, or a different user) may have completed some steps in relation with a buying process of the (e.g., eBay) mobile application, and may be currently in a certain (e.g., payment) flow of the buying process about which he is confused, or he may be delighted with a particular component of the user experience provided by a relevant portion of a user interface provided by the mobile application. The customer may have previously set a three-finger swipe as his “feedback” gesture. When the user swipes his three fingers on or in proximity of his mobile device (e.g., upwards, downwards, diagonally, horizontally, and so on), a system provider (e.g., eBay) providing an online transaction service including the buying process may recognize that the user has just completed the payment flow for an item, and that the user would like to provide feedback on this recently completed (e.g., payment) action. The system provider may use a “Completed Payment” status tag as a key flow/action to collect relevant structured satisfaction data associated with a user interface for the payment flow. The user may be prompted with a survey including one or more questions with respect to the user experience the user had during the payment flow. For example, the questions in the survey may be presented in a form of sliders that allow the user to rate his experience by moving these with a natural swipe to either left or right. The user may also enter detailed description about the experience in text including his desire to reuse or recommend the application. This feedback process may include prompting a user interface (e.g., a page) to report a “bug” (e.g., an application error or incorrect data), as illustrated in FIG. 2.

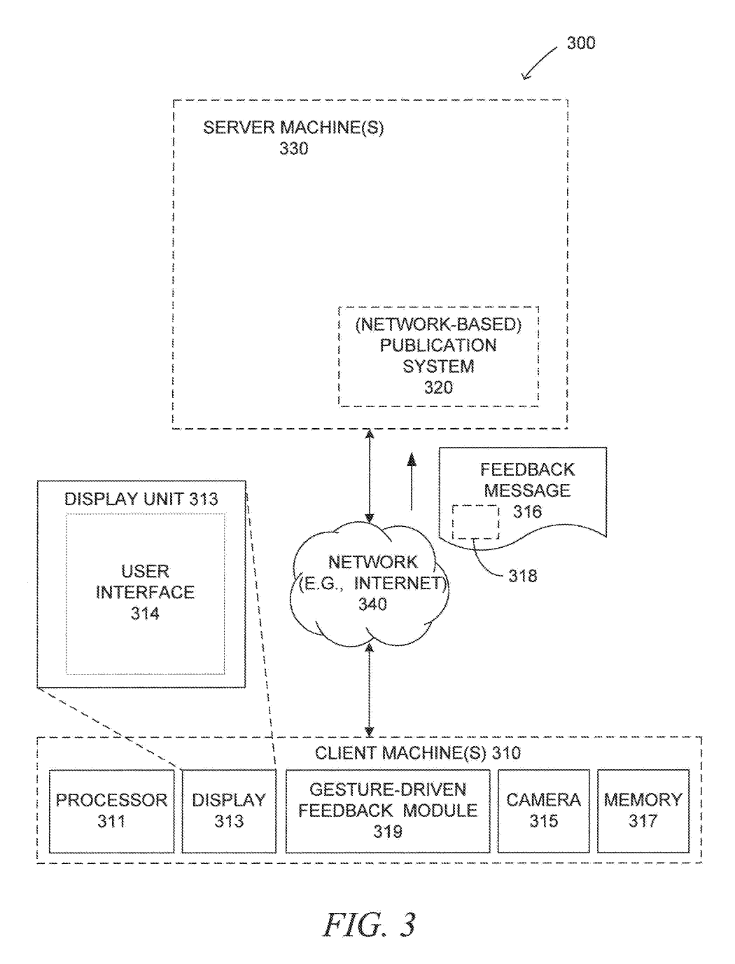

In various embodiments, a user gesture performed on or in proximity of a user device corresponding to a user may be detected during execution of a user interface in relation with an application. The (detected) user gesture may be compared against at least one predetermined gesture. A feedback message associated with the application may be generated based on determining that the (detected) user gesture matches the at least one predetermined gesture. The generating of the feedback message may include automatically capturing a screen image of the user interface and inserting the (captured) screen image as at least part of the feedback message. Various embodiments that incorporate these mechanisms are described below in more detail with respect to FIGS. 3-7.

FIG. 3 depicts a block diagram illustrating a system 300 in a network environment for a gesture-driven feedback mechanism (e.g., the user device 110 and the feedback user interface 120 therein), according to various embodiments. The system 300 may include one or more server machines 330 connected through a network (e.g., the Internet) 340 to one or more client machines 310 (e.g., the user device 110). In various embodiments, for example, each of the one or more client machines 310 may comprise a user device, such as a personal computer (PC), notebook, netbook, tablet PC, server, cell phone (e.g., smartphone), personal digital assistant (PDA), television (TV), set top box, or the like.

The server machines 330 may comprise a network-based publication system 320, such as a network-based trading platform. In various embodiments, the network-based trading platform may provide one or more marketplace applications, payment applications, and other resources. The marketplace applications may provide a number of marketplace functions and services to users that access the marketplace. The payment applications, likewise, may provide a number of payment services and functions to users. The network-based trading platform may display various items listed on the trading platform.

The embodiments discussed in this specification are not limited to network-based trading platforms, however. In other embodiments, other web service platforms, such as a social networking websites, news aggregating websites, web portals, network-based advertising platforms, or any other systems that provide web services to users, may be employed. Furthermore, more than one platform may be supported by the network-based publication system 320, and each platform may reside on a separate server machine 330 from the network-based publication system 320.

The client machine 310 may comprise (e.g., host) a processor 311, a display 313, a camera 315, a memory 317, and a gesture-driven feedback module 319. Although not shown in FIG. 3, the client machine 310 may further comprise (e.g., be furnished with) one or more sensors that are capable of capture characteristics, such as shape, size, speed, direction, or pressure, of body (e.g., finger) or input device (e.g., electronic pen) movements. Such sensors may be installed in relation with the display 313 or other portion (e.g., the camera 315) of the client machine 310.

In various embodiments, a user gesture of a user of the client machine 310 (e.g., the user device 110) may be detected and received via the display 313 (e.g., a touch screen) or the camera 315 (e.g., a front facing camera) during an execution of a user interface 314 in relation with an application executing on the client machine 310, for example, as explained with respect to FIG. 1. The application may comprise an (e.g., applet) application executing within the scope of the web browser (e.g., an online listing, shopping, or payment application) or a native program having a unique user interface customized for a specific purpose (e.g., a stock trading application). In some embodiments, the gesture-driven feedback module 319 (e.g., the feedback user interface 120 in FIG. 1) may extract, from the (detected) user gesture, information identifying and describing the characteristics, such as shape, size, speed, direction, or pressure, of the body (e.g., finger) movements related to the user gesture. Based at least in part on this information, the gesture-driven feedback module 319 may determine (e.g., confirm) the (detected) user gesture as a recognizable user gesture (e.g., the three-finger swipe shown in FIG. 1).

When the (detected) user gesture is determined as an unrecognizable (e.g., random) user gesture, the gesture-driven feedback module 319 may let the application keep executing, for example, without any interruption or after presenting an error message (e.g., “unrecognized gesture”) via the display 313. This allows preventing unwanted trigger of a certain functionality of the client machine 310 (e.g., the gesture-driven feedback module 319) when the user makes arbitrary gestures.

When the (detected) user gesture is determined as the recognizable user gesture, the gesture-driven feedback module 319 may compare the (detected and recognized) user gesture against one or more predetermined gestures stored (e.g., pre-registered) in the client machine 310. Each of the one or more predetermined gestures may be registered by the user in advance as his or her choice of gesture that is affiliated with one of certain functionality of the client machine 310.

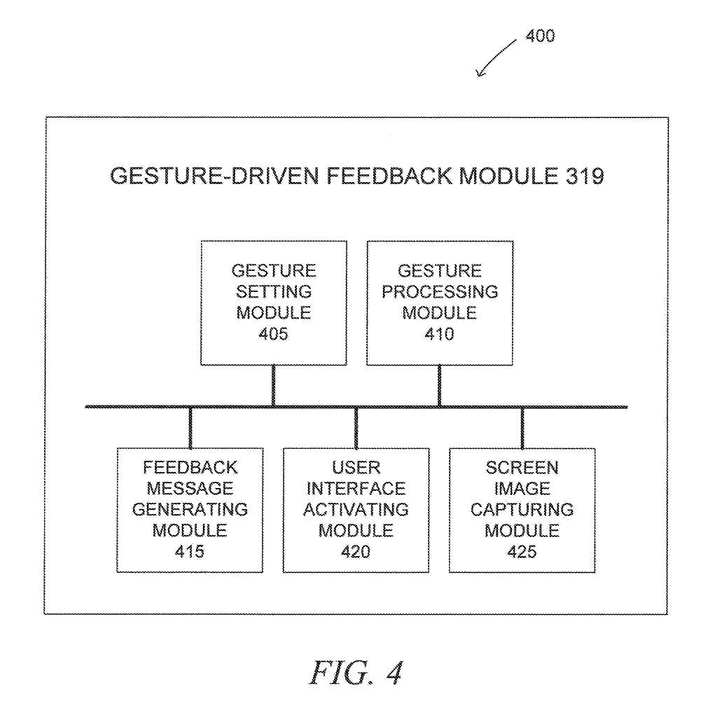

The gesture-driven feedback module 319 may generate a feedback message 316 (e.g., the bug report in FIG. 2) associated with the application based on determining that the (detected) user gesture (e.g., the three finger swipe in FIG. 2) matches at least one of the one or more predetermined gestures, for example, as explained with respect to FIG. 2. In various embodiments, the gesture-driven feedback module 319 may capture a screen image 318 (e.g., a still cut or a video clip) of the user interface 314 in relation with the application, and insert the screen image 318 as at least part of the feedback message 316. In various embodiments, the gesture-driven feedback module 319 may capture status information of a certain flow of the application at the time of the user gesture being detected, and transmit the status information to the network-based publication system 320 so that the network-based publication system 320 can provide functionalities (e.g., menus, pages, user interfaces, customer service agent actions, and so on) specific to the certain flow based on the status information. For example, the status information of the certain flow may be transmitted as at least part of the feedback message 316 or as a separate message (not shown). More information regarding the gesture-driven feedback module 319 is provided below with respect to FIGS. 4-6.

In one embodiment, contents displayed via the user interface 314 may be data provided via the network (e.g., the Internet) 340, for example, from the network-based publication system 320. In another embodiment, the contents displayed via the user interface 314 may be locally provided without going through the network 340, for example, via an external storage device, such as a Universal Serial Bus (USB) memory, a Digital Versatile/Video Disc (DVD), a Compact Disc (CD), or a Blu-ray Disc (BD). In various embodiments, the display 313 to present the user interface may comprise a touch screen device capable of capturing a user's finger or electronic pen movements thereon.

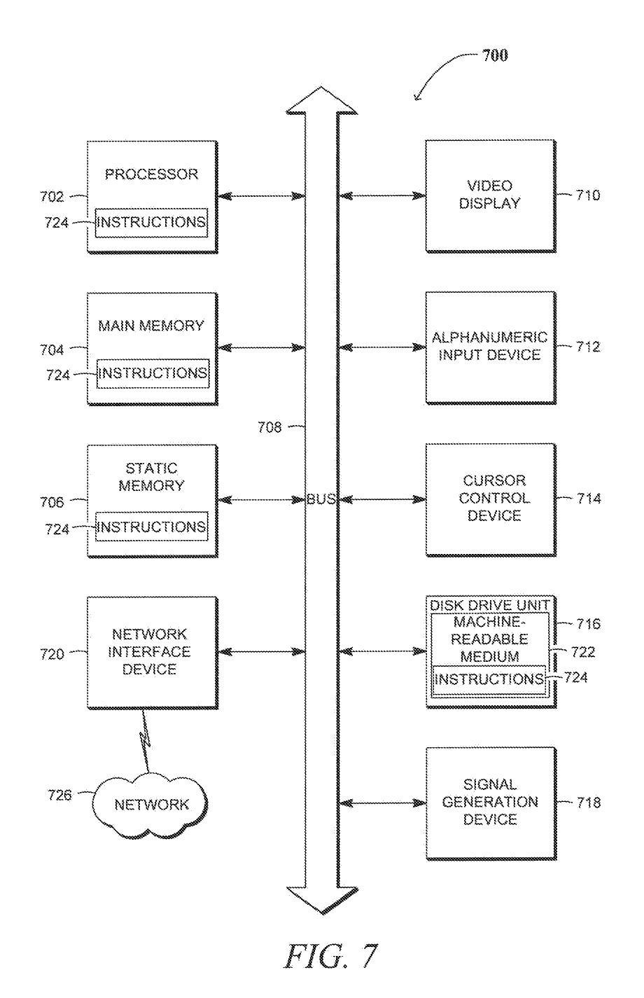

The processor 311 may provide processing capacity for the client machine 310, including the gesture-driven feedback module 319, and the memory 317 may comprise a storage device to store data (e.g., information identifying and describing the (detected) user gesture or the one or more pre-registered user gestures) to be processed (e.g., detected or compared) by the processor 311. In various embodiments, the memory 317 may store a list of user gestures and information identifying and describing characteristics of each of the user gestures. More information regarding the processor 311 and the memory 317 is provided below with respect to FIG. 7.

It is noted that while FIG. 3 illustrates the client machine 310 and the server machine 330 in a client-server architecture, other embodiments are not limited to this architecture and may equally find applications in a distributed, peer-to-peer, or standalone architectures.

FIG. 4 is a schematic diagram 400 illustrating example modules of the gesture-driven feedback module 319 of the client machine 310 to execute a gesture driven feedback mechanism, according to various embodiments. The gesture-driven feedback module 319 may comprise a web browser, a gadget application that operates in a background of the computing environment of the client machine 310, or a combination thereof. The client machine 310 may be configured to permit its user to access the various applications, resources, and capabilities of the web services provided by the network-based publication system 320, for example, via the gesture-driven feedback module 319. In some embodiments, for example, the gesture-driven feedback module 319 may comprise a gesture setting module 405, a gesture processing module 410, a feedback message generating module 415, a user interface activating module 420, and a screen image capturing module 425.

In various embodiments, an apparatus (e.g., the client machine 310) may comprise an input/output (I/O) unit (e.g., the display 313) to detect user gestures on or in proximity of the apparatus, and one or more processors (e.g., the processor 311) to execute a feedback management module (e.g., the gesture-driven feedback module 319). In some embodiments, the feedback management module may be configured to: detect, via the I/O unit, a user gesture performed during execution of a user interface (e.g., the user interface 314) in relation with an application; compare the (detected) user gesture against at least one predetermined gesture; and generate a feedback message (e.g., the feedback message 316) associated with the application based on determining that the user gesture matches the at least one predetermined gesture. For example, in one embodiment, at least one of detecting the user gesture or comparing the user gesture against the at least one predetermined gesture may be performed as a function of the gesture processing module 410, and generating of the feedback message may be performed as a function of the feedback message generating module 415.

In various embodiments, the generating of the feedback may include automatically capturing a screen image (e.g., the screen image 318) of the user interface (e.g., the user interface 314) and inserting the screen image as at least part of the feedback message. For example, in one embodiment, capturing the screen image may be performed as a function of the screen image capturing module 425.

In various embodiments, the at least one predetermined gesture may be previously registered via the feedback management module (e.g., the gesture-driven feedback module 319), for example, at the time of a user registration with the application. In other embodiments, the feedback management module (e.g., the gesture-driven feedback module 319) may present the user with a list of a plurality of user gestures, for example, stored in an associated memory (e.g., the memory 317), and register one or more of the presented user gestures as the at least one predetermined user gesture based on a user selection. In one embodiment, for example, registering of the at least one predetermined gesture may be performed as a function of a gesture setting module 405.

In various embodiments, the I/O unit (e.g., the display 313) may comprise a screen (e.g., a touch screen) configured to detect, as the user gesture, at least one finger or an input device moving on or in proximity of the screen substantially in a geometric shape, vertically, horizontally, diagonally or combination thereof.

In various embodiments, the I/O unit (e.g., the display 313) may comprise at least one sensor configured to detect, as the user gesture, the apparatus shaking or moving substantially in a geometric shape, vertically, horizontally, diagonally or combination thereof.

In various embodiments, the feedback management module (e.g., the gesture-driven feedback module 319) may be configured to activate, responsive to detecting the user gesture matching the at least one predetermined gesture, another user interface (e.g., the feedback user interface 120 in FIG. 1) in relation with the application to receive user inputs as at least part of the feedback message.

In various embodiments, the feedback management module (e.g., the gesture-driven feedback module 319) may be configured to deactivate the other user interface responsive to detecting another user gesture that is similar to the user gesture previously performed to activate the other user interface.

In various embodiments, the feedback management module (e.g., the gesture-driven feedback module 319) may be configured to deactivate the other user interface responsive to detecting another user gesture that matches another predetermined gesture being performed on or in the proximity of the apparatus.

In various embodiments, the feedback management module (e.g., the gesture-driven feedback module 319) may be configured to activate a plurality of menus within the other user interface, with each of the plurality of menus configured to receive a corresponding portion of the user inputs as a different category (e.g., a bug report or a customer service request) of feedback for the application.

In various embodiments, the feedback management module (e.g., the gesture-driven feedback module 319) may be configured to automatically perform, upon activation of the other user interface, a plurality of functions of the other user interface aggregated as a macro function. For example, in one embodiment, reporting a program error (e.g., a bug) and requesting technical support (e.g., from a customer service center) may be executed, concurrently or sequentially, upon activation of the other user interface. For example, in one embodiment, activating or deactivating of the other user interface (or menus provided within the other user interface) may be performed as a function of the user interface activating module 420.

In various embodiments, the feedback management module (e.g., the gesture-driven feedback module 319) may be configured to capture one or more screen images of at least one process flow (e.g., a function or a menu) performed (e.g., by the application) subsequent to the activation of the other user interface. For example, in one embodiment, capturing the one or more screen images of the at least one process flow (e.g., the function or menu by the application) may be performed as a function of the screen image capturing module 425. In some embodiments, capturing the one or more screen images of the at least one process flow (e.g., the function or menu by the application) may be performed as a function of an additional module (not shown) separate from the modules 405-425.

In various embodiments, the apparatus (e.g., the client machine 310) may further comprise memory (e.g., the memory 317) to store information identifying and describing the at least one predetermined gesture. Other embodiments may be possible.

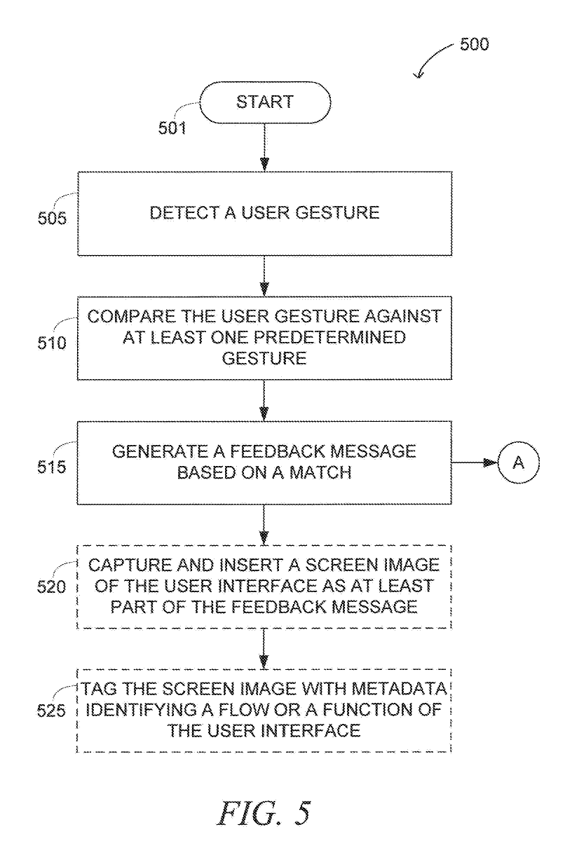

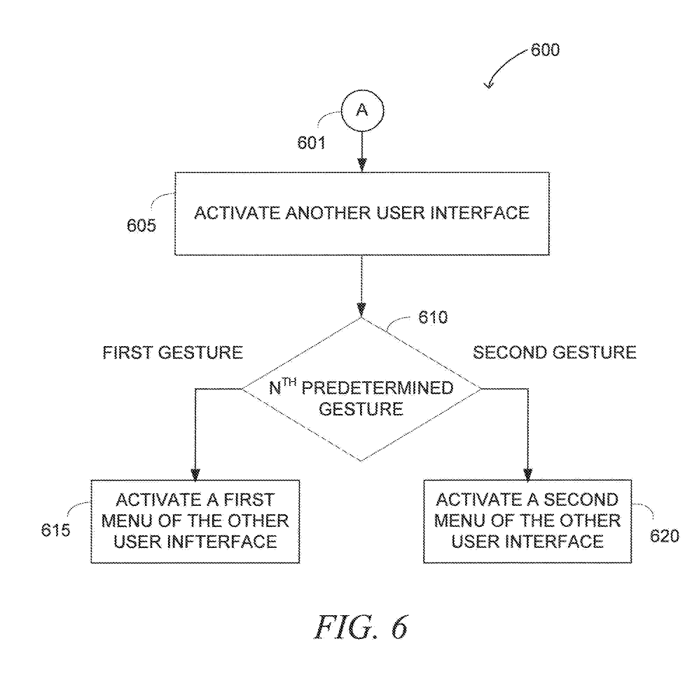

Each of the modules described above with respect to FIGS. 3-4 may be implemented by hardware (e.g., circuit), firmware, software or any combinations thereof. Although each of the modules is described above as a separate module, all or some of the modules in FIGS. 3-4 may be implemented as a single entity (e.g., module or circuit) and still maintain the same functionality. Still further embodiments may be realized. Some of these may include a variety of methods. The system 300 and/or its component apparatus (e.g., the client machine 310 or the server machine 330) in FIG. 3 may be used to implement, among other things, the processing associated with various methods of FIGS. 5-6 discussed below.

FIG. 5 shows a flow diagram illustrating a method 500 at the client machine (e.g., the user device 110) for generating a feedback message based on a user gesture, according to various embodiments. For example, in various embodiments, at least one portion of the method 500 may be performed by the gesture-driven feedback module 319 of FIG. 3. The method 500 may commence at operation 501 and proceed to operation 505, where a user gesture performed on or in proximity of a user device (e.g., the client machine 310), such as a touch screen thereof, during execution of a (e.g, first) user interface in relation with an application may be detected. In various embodiments, the (e.g., first) user interface may comprise one or more pages including menus for performing specific functionalities of the application (e.g., word processing menus as in a word application and item listing, selling, buying, voucher issuing, or voucher redemption for an online transaction application). At operation 510, the (detected) user gesture may be compared against at least one predetermined gesture. At operation 515, a feedback message associated with the application may be generated based on determining that the (detected) user gesture matches the at least one predetermined gesture.

In various embodiments, at operation 520, generating of the feedback message may include automatically capturing a screen image of the user interface in relation with the application and inserting the screen image as at least part of the feedback message. In various embodiments, at operation 525, generating of the feedback message may include tagging the screen image with metadata identifying a flow (e.g., a function), such as listing, searching, adding into a wish list, buying, paying for, an item, and so on, of the user interface in relation with the application at the time of the user gesture being detected.

In some embodiments, capturing the screen image of the user interface (described with respect to operation 520) or tagging the (captured) screen image with the metadata identifying the flow of the user interface (described with respect to operation 525) may be performed independently of generating the feedback message. In such a scenario, the screen image may be automatically captured upon the user gesture being detected and recognized as the at least one predetermined gesture. When captured, the screen image of the user interface may be utilized for functions (e.g., menus) other than generating the feedback. For example, in some embodiments, the (captured) screen image may be printed out, inserted as part of a document that is being currently drafted, for example, using the application, uploaded onto a network-based social networking service (e.g., Facebook.com or Twitter.com). These functions may be performed as part of capturing of the user gesture or as a separate operation that responds to additional user input (e.g., another touch or non-touch user gesture).

In various embodiments, generating of the feedback message may include inserting, as at least part of the feedback message, a physical location or a timestamp of the user device at the time of the user gesture being detected. In various embodiments, other activities may be further performed in relation with operation 515, as one or more operations labeled “A.” For example, when the user gesture is detected, information identifying and describing the (detected) user gesture may be analyzed, and the (detected) user gesture may be determined as matching one of a plurality of preregistered user gestures. A different function of a plurality of functions of the user device may be activated depending on the (determined) preregistered user gesture. More information regarding the other activities labeled “A” is provided below with respect to FIG. 6.

FIG. 6 shows a flow diagram illustrating a method 600 at the client machine 310 (e.g., the user device 110) for activating different functions of the user device based on user gestures, according to various embodiments. For example, in various embodiments, at least one portion of the method 600 may be performed by the gesture-driven feedback module 319 of FIG. 3. The method 600 may commence at operation 601 and proceed to operation 605, where another (e.g., a second) user interface (e.g., the feedback user interface 120) in relation with the application may be activated, for example, to receive user input as at least part of the feedback message. At operation 610, it is determined whether the (detected) user gesture matches Nth (e.g., first, second, third, and so on) predetermined gesture of a plurality of predetermined gestures.

At operation 615, a first menu (e.g., reporting a bug in the application being executed) of the other (e.g., the second) user device (e.g., the feedback user interface 120) may be activated based on determining that the (detected) user gesture matches a first one (e.g., at least one finger swipe) of the plurality of predetermined gestures (e.g., a circle, rectangle, triangle, “X,” and so on), as shown by the flow indicated by the left arrow.

At operation 620, a second menu (e.g., requesting a customer tech support) of the user device may be activated based on determining that the (detected) user gesture matches a second one (e.g., “W”) of the plurality of predetermined gestures, as shown by the flow indicated by the right arrow.

In various embodiments, activating the first menu may comprise designating the feedback message as a first category of feedback, and activating the second menu may comprise designating the feedback message as a second category of feedback.

In various embodiments, activating the other user interface (e.g., the feedback user interface 120) may comprise automatically capturing a screen image of the other user interface and inserting the screen image of the other user interface as at least part of the feedback message.

In various embodiments, generating the feedback message (e.g., the feedback message 316) may comprise: determining a flow (e.g., searching for an item for transaction, or purchasing the item, via the network-based publication system 320) of the application at the time of detecting the user gesture; activating a first user interface to receive the feedback message as a first type of feedback (e.g., a guide showing how to find similar items from a same or different vendor) based on determining that the flow of the application matches a first one of a plurality of flows provided by the application; and activating a second user interface (e.g., a suggestion regarding how to make online payment easier) to receive the feedback as a second type of feedback based on determining that the flow of the application matches a second one of the plurality of flows.

In various embodiments, generating the feedback message based on the (detected) user gesture may comprise causing an email program to generate an email such that the email includes the feedback message as at least part thereof.

In various embodiments, the method may further comprise allowing the user to select, as the at least one predetermined gesture, one of a plurality of gestures stored in the user device, for example, as a function of the gesture setting module 405, as described with respect to FIG. 4. Other embodiments are possible.

The methods 500 and/or 600 may be performed by processing logic that may comprise hardware (e.g., dedicated logic, programmable logic, microcode, etc.), such as at least one processor, software (such as run on a general purpose computing system or a dedicated machine), firmware, or any combination of these. It is noted that although the methods 500 and 600 are explained above with respect to the client machine 310 (e.g., the user device 110) including the gesture-driven feedback module 319 in FIG. 3, those skilled in the art will recognize that the methods 500 and/or 600 may be performed by other systems and/or devices that provide substantially the same functionalities as the client machine 310 (e.g., the user device 110).

Although only some activities are described with respect to FIGS. 5 and 6, the methods 500 and 600, according to various embodiments, may perform other activities, such as operations performed by the camera 315 (e.g., a front-facing or rear-facing camera) and/or the server machine 330 (or the network-based publication system 320 therein) in FIG. 3, in addition to and/or as an alternative to the activities described with respect to FIGS. 5 and 6.

The methods 500 and 600 described herein do not have to be executed in the order described, or in any particular order. Moreover, various activities described with respect to the methods 500 and 600 identified herein may be executed in repetitive, serial, heuristic, or parallel fashion, or any combinations thereof. The individual activities of the methods 500 and 600 shown in FIGS. 5 and 6 may also be combined with each other and/or substituted, one for another, in various ways. Information, including parameters, commands, operands, and other data, may be sent and received between corresponding modules or elements in the form of one or more carrier waves. Thus, many other embodiments may be realized.

In various embodiments, the methods 500 and 600 shown in FIGS. 5 and 6 may be implemented in various devices, as well as in a machine-readable medium, such as a storage device, where the methods 500 and 600 are adapted to be executed by one or more processors. Further details of such embodiments are described below with respect to FIG. 7.

FIG. 7 is a diagrammatic representation of a machine (e.g., the client machine(s) 310 or the server machine(s) 330) in the example form of a computer system 700, according to various embodiments, within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a user device in a server-client network environment, or as a peer machine in a peer-to-peer (or distributed) network environment. The machine may be a server computer, a client computer, a PC, a tablet PC, a set-top box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700, comprising an article of manufacture, may include a processor 702, such as the processor 311, (e.g., a central processing unit (CPU), a graphics processing unit (GPU), or both), a main memory 704 and a static memory 706, such as the memory 317, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker or an antenna), and a network interface device 720.

The disk drive unit 716 may include a machine-readable medium 722 on which is stored one or more sets of instructions 724 (e.g., software) embodying any one or more of the methodologies or functions described herein. The instructions 724 may also reside, completely or at least partially, within the main memory 704, static memory 706, and/or within the processor 702 during execution thereof by the computer system 700, with the main memory 704, static memory 706 and the processor 702 also constituting machine-readable media. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium, such as a storage device, that is capable of storing, encoding, or carrying a set of instructions for execution by the machine and that cause the machine to perform any one or more of the methodologies of various embodiments disclosed herein. The term “machine-readable medium” shall accordingly be taken to include, but not be limited to, solid-state memories, optical media, and magnetic media.

Thus, a method, apparatus, and system for generating a feedback message based on a user gesture have been provided. Although the method, apparatus, and system have been described with reference to specific example embodiments, it will be evident that various modifications and changes may be made to these embodiments without departing from the broader spirit and scope thereof. The various modules and/or engines described herein may be implemented in hardware, software, or a combination of these. Accordingly, the specification and drawings are to be regarded in an illustrative rather than a restrictive sense.

According to various embodiments, a user may no longer be restricted to leaving feedback only within designated areas of an application executing on his user device or only in response to a certain sequence of events occurring (e.g., at the end of a transaction or only after having to go through one or more additional pages or user interfaces). Instead, a user interface to receive and transmit the feedback may be instantaneously available by user gestures from any screen or flow in relation with the application. A service provider may receive the feedback as appropriately sorted (e.g., categorized, for example, as bug report or improvement suggestion, and so on) based on the flow or context at the time of the user gesture that triggers the feedback mechanism being detected, with a screen image showing the flow or context of the application in detail. This may reduce the need for the service provider to reorganize unsorted (e.g., inappropriately categorized) feedback messages received from users, or to furnish the users with on-call customer services to obtain detailed information about the relevant application flow or context to provide a proper response in a timely manner. Higher frequency of use, enhanced user experiences, or efficient management of a feedback database (affiliated with the service provider), with respect to user devices (and applications thereon), may result.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus comprising:
an input/output (I/O) unit to detect user gestures on or in proximity of the apparatus; and
one or more processors to execute a feedback management module, the feedback management module configured to:
detect, via the I/O unit, a user gesture performed during execution of a user interface in relation with an application;
compare the user gesture against at least one predetermined gesture; and
generate a feedback message associated with the application based on determining that the user gesture matches the at least one predetermined gesture, the generating including automatically capturing a screen image of the user interface and inserting the screen image as at least part of the feedback message.

2. The apparatus of claim 1, wherein the I/O unit comprises:
a screen configured to detect, as the user gesture, at least one finger or an input device moving on or in proximity of the screen substantially in a geometric shape, vertically, horizontally, diagonally or combination thereof.

3. The apparatus of claim 1, wherein the I/O unit comprises:
at least one sensor configured to detect, as the user gesture, the apparatus shaking or moving substantially in a geometric shape, vertically, horizontally, diagonally or combination thereof.

4. The apparatus of claim 1, wherein the feedback management module is configured to:
activate, responsive to detecting the user gesture matching the at least one predetermined gesture, another user interface in relation with the application to receive user inputs as at least part of the feedback message.

5. The apparatus of claim 4, wherein the feedback management module is configured to:
deactivate the other user interface responsive to detecting another user gesture that is similar to the user gesture previously performed to activate the other user interface.

6. The apparatus of claim 4, wherein the feedback management module is configured to:
deactivate the other user interface responsive to detecting another user gesture that matches another predetermined gesture.

7. The apparatus of claim 4, wherein the feedback management module is configured to:
activate a plurality of menus within the other user interface, each of the plurality of menus to receive a corresponding portion of the user inputs as a different category of feedback for the application.

8. The apparatus of claim 4, wherein the feedback management module is configured to:
automatically perform, upon activation of the other user device, a plurality of functions of the other user interface aggregated as a macro function.

9. The apparatus of claim 4, wherein the feedback management module is configured to:
capture one or more screen images of at least one flow performed subsequent to the activation of the other user interface.

10. The apparatus of claim 1, further comprising:
memory to store information identifying and describing the at least one predetermined gesture.

11. A method comprising:
detecting, via a user device corresponding to a user, a user gesture performed on or in proximity of the user device during execution of a user interface in relation with an application;
comparing the user gesture against at least one predetermined gesture; and
generating, using one or more processors, a feedback message associated with the application based on determining that the user gesture matches the at least one predetermined gesture, the generating including automatically capturing a screen image of the user interface and inserting the screen image as at least part of the feedback message.

12. The method of claim 11, wherein the generating comprises:
tagging the screen image with metadata identifying a flow or a function of the user interface at the time of the user gesture being detected.

13. The method of claim 11, wherein the generating comprises:
inserting, as at least part of the feedback message, a physical location or a timestamp of the user device at the time of the user gesture being detected.

14. The method of claim 11, wherein the generating comprises:
activating another user interface in relation with the application to receive user inputs as at least part of the feedback message.

15. The method of claim 14, wherein the at least one predetermined gesture comprises a plurality of predetermined gestures including a first predetermined gesture and a second predetermined gesture, wherein the activating comprises:
activating a first menu within the other user interface based on determining that the user gesture matches the first predetermined gesture; and
activating a second menu within the other user interface based on determining that the user gesture matches the second predetermined gesture.

16. The method of claim 15, wherein the activating the first menu comprises designating the feedback message as a first category of feedback; and
wherein the activating the second menu comprises designating the feedback message as a second category of feedback.

17. The method of claim 11, wherein the generating the feedback comprises:
determining a flow of the application at the time of detecting the user gesture;
activating a first user interface to receive the feedback as a first type of feedback based on determining that the flow of the application matches a first one of a plurality of flows provided by the application; and
activating a second user interface to receive the feedback as a second type of feedback based on determining that the flow of the application matches a second one of the plurality of flows.

18. The method of claim 11, wherein the generating comprises:
causing an email program to generate an email such that the email includes the feedback message as at least part thereof.

19. The method of claim 11, further comprising:
allowing the user to select, as the at least one predetermined gesture, one of a plurality of gestures stored in the user device.

20. A non-transitory machine-readable storage device storing instructions that, when executed by one or more processors, cause the one or more processors to perform operations comprising:
detecting, via a user device corresponding to a user, a user gesture performed on or in proximity of the user device during execution of a user interface in relation with an application;
comparing the user gesture against at least one predetermined gesture; and
generating a feedback message associated with the application based on determining that the user gesture matches the at least one predetermined gesture, the generating including automatically capturing a screen image of the user interface and inserting the screen image as at least part of the feedback message.
